(19) United States
(12) Patent Application Publication
(10) Pub. No.: US 2010/0104768 A1
(43) Pub. Date: Apr. 29, 2010

(54) METHOD OF MAKING OPTICAL TRANSDUCERS

(75) Inventors: Shuaigang Xiao, Cranberry Twp, PA (US); XiaoMin Yang, Sewickley, PA (US); Keith Mountfield, Pittsburgh, PA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/260,228

(22) Filed: Oct. 29, 2008

(51) Int. Cl. B05D 3/06; B05D 5/12

(52) U.S. Cl. 427/552; 427/551

(57) ABSTRACT

A process for making an optical transducer that includes depositing a lower molecular weight first layer and a higher molecular weight second layer. E-beam radiation is applied to the first and second layers which are developed to form an aperture. The aperture includes a resist protrusion in the second layer. The resist protrusion protrudes outward beyond the first layer. Metal is evaporated through the aperture to form the optical transducer. The resist protrusion defines a shape of a concave metal transducer corner.

### BACKGROUND OF THE INVENTION

Optical transducers for use in heat assisted magnetic recording heads are known. There is a desire to use such transducer in higher density data storage drives in the range of about 1 Terabit per square inch data density. Existing methods, however, use chemically amplified resist methods and are not able to reliably produce small features in a sub-20 nanometer range needed for the range of 1 Terabit per square inch.

Embodiments of the present invention provide solutions to these and other problems, and offer other advantages over the prior art.

### SUMMARY OF THE INVENTION

Disclosed is a process for making an optical transducer. The process comprises depositing first and second layers on a substrate. The second layer comprises a resist material with a higher molecular weigh than a lower molecular weight resist material of the first layer.

The process comprises defining a shape of an optical transducer that includes a concave metal transducer corner. The process comprises providing e-beam radiation to the first and second layers.

The process comprises developing the first and second layers to form an aperture. The aperture includes a resist protrusion in the second layer. The resist protrusion protrudes outward beyond the first layer and overhangs the substrate.

The process comprises evaporating metal through the aperture onto the substrate to form the optical transducer. The resist protrusion defines a shape of the concave metal transducer corner. The process comprises lifting off the first and second resist layers.

According to one aspect, the e-beam radiation includes a raster grid and the e-beam radiation is rasterized to include a pattern of the optical sensor in the optical grid, the pattern being fixed to the raster grid.

According to another aspect, the defining of the shape of the optical transducer comprises imprinting the second layer of resist material with a nano-imprinting lithography mold.

Other features and benefits that characterize embodiments of the present invention will be apparent upon reading the following detailed description and review of the associated drawings.

### BRIEF DESCRIPTION OF THE DRAWINGS

FIG. 1 is an isometric view of a disc drive.

FIG. 2 illustrates a nearfield transducer (NFT).

FIG. 3 illustrates a NFT resist layer pattern formed using chemically amplified resists and thermal shrinking.

FIG. 4 illustrates a NFT resist layer pattern during successive stages of anisotropic thermal shrinking.

FIG. 5 illustrates optical transducer manufacturing processes.

FIG. 6 illustrates an oblique view of an in-process optical transducer.

FIG. 7 illustrates an enlarged cross-sectional view of exemplary resist deposits defining a peg width of a near field transducer.

FIG. 8 illustrates three examples of patterns of NFTs that are fix-to-grid patterns of a circular disc and a peg.

FIG. 9 illustrates a graph of e-beam pixel spot size as a function of e-beam current.

FIG. 10 illustrates a series of sample NFTs prepared using the method of FIG. 5.

FIGS. 11A, 11B, 11C, 11D illustrate alternative shapes of NFTs.

FIG. 12 illustrates process stages in manufacturing an optical transducer.

### DETAILED DESCRIPTION OF ILLUSTRATIVE EMBODIMENTS

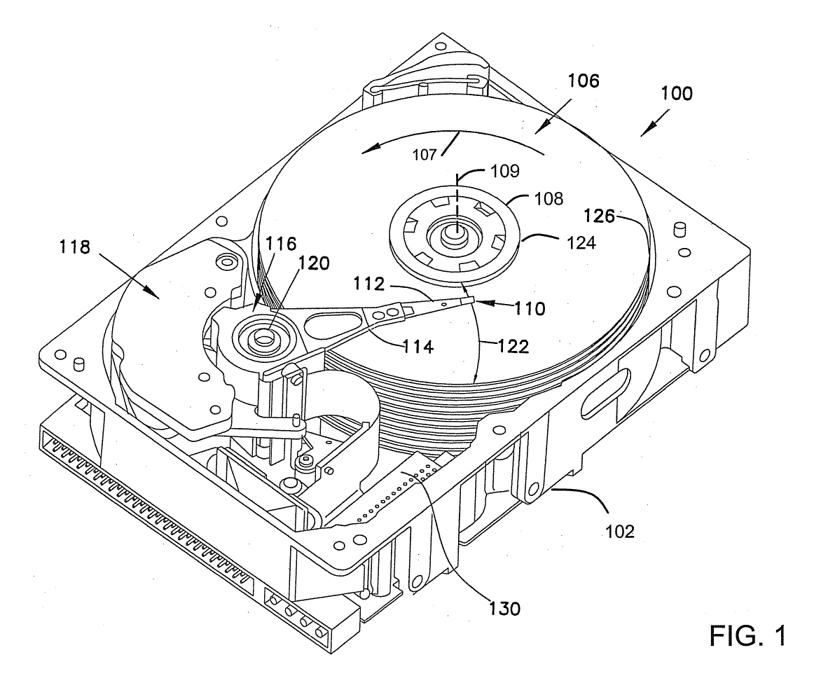

In FIGS. 1, 5-12, processes for manufacturing an optical transducer with a sub 20 nanometer size scale are shown. The processes comprise depositing first and second layers on a substrate. The second layer comprises a resist material with a higher molecular weigh than a lower molecular weight resist material of the first layer. The processes comprise defining a shape of an optical transducer that includes a concave metal transducer corner. The processes comprise providing e-beam radiation to the first and second layers. The processes comprise developing the first and second layers to form an aperture. The aperture includes a resist protrusion in the second layer. The resist protrusion protrudes outward beyond the first layer and overhangs the substrate.

The processes comprise evaporating metal through the aperture onto the substrate to form the optical transducer. The resist protrusion defines a shape of the concave metal transducer corner. The process comprises lifting off the first and second resist layers.

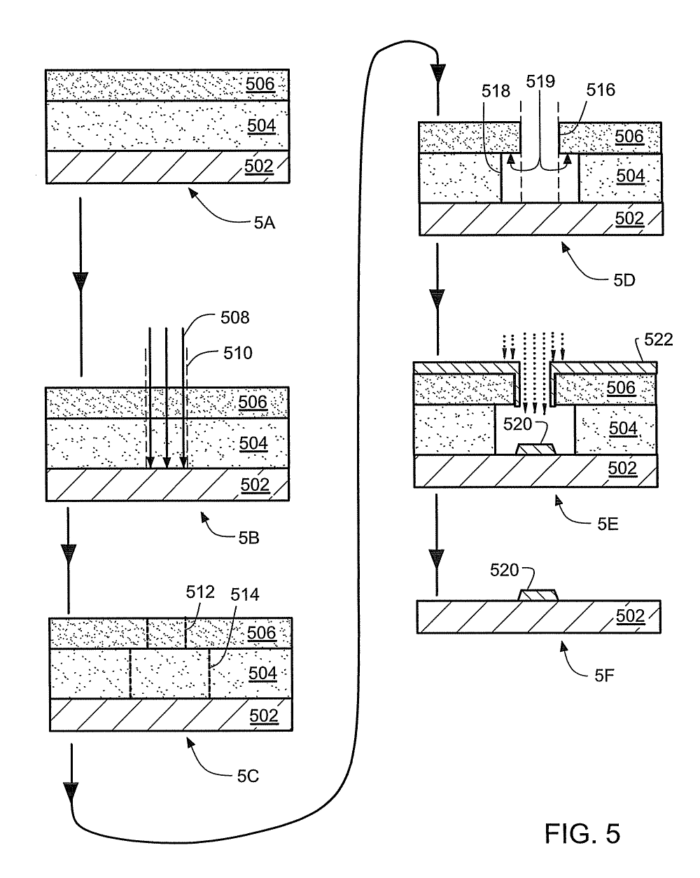

According to one aspect shown in FIG. 5, the e-beam radiation includes a raster grid and the e-beam radiation is rasterized to include a pattern of the optical sensor in the optical grid, the pattern being fixed to the raster grid. According to another aspect, the defining of the shape of the optical transducer comprises imprinting the second layer of resist material with a nano-imprinting lithography mold.

FIG. 1 is an isometric view of a disc drive 100 in which the presently disclosed optical transducers are useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation in a direction 107 about a central axis 109. Each disc surface has an associated disc head slider 110 which is mounted to disc drive 100 for communication with the disc surface. In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown).

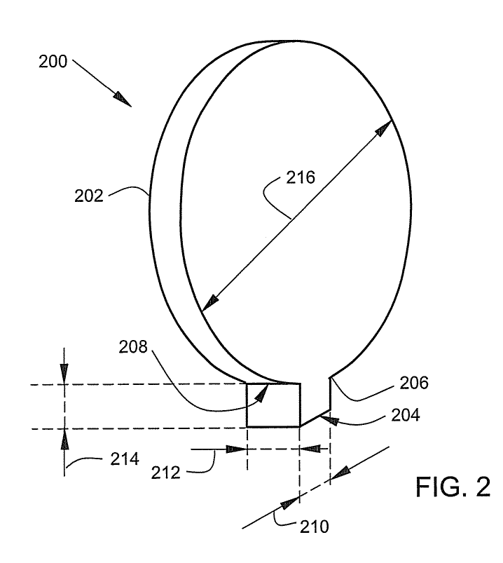

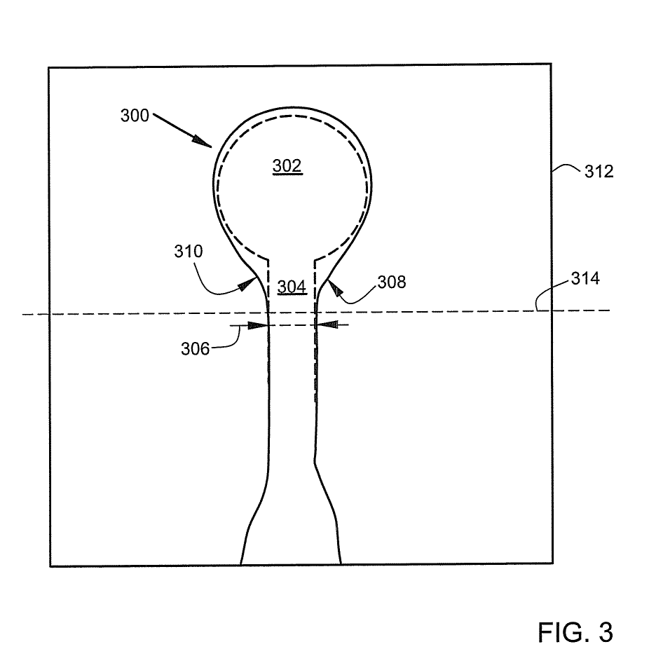

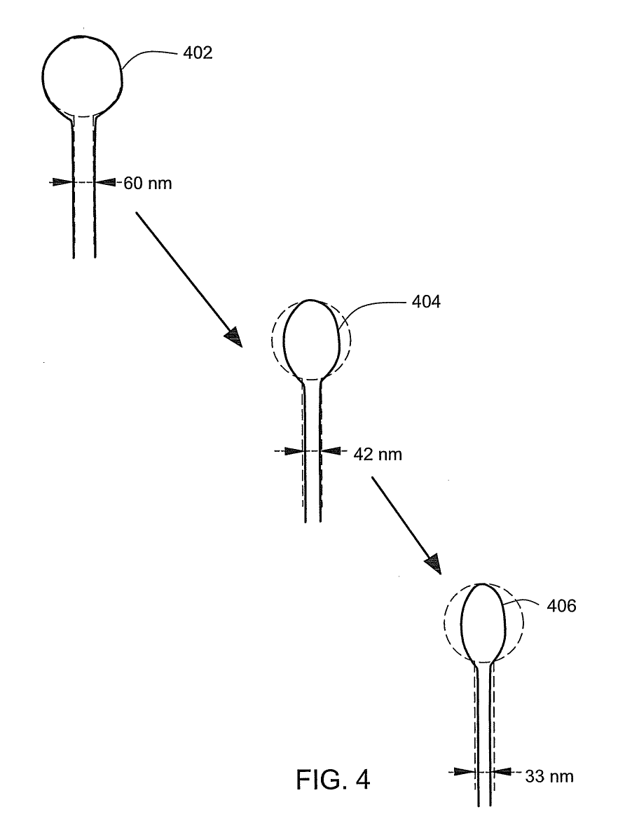

FIG. 2 illustrates a lollipop-shaped structure of a nearfield transducer (NFT) 200. The nearfield transducer 200 is useful in heat-assisted magnetic recording heads (HAMR heads) such as those illustrated in US Patent Publication US 20050289576A1 Challener, US Patent Publication US 20080170319A1 Seigler et al., as well as in other HAMR head designs. The nearfield transducer 200 comprises a metal deposit with a shape that includes a circular disc portion 202 and a peg portion 204. The disc portion 202 and the peg portion 204 join at corner regions 206, 208 which are referred to herein as “breakpoints” 206, 208. The nearfield transducer 200 has a desired reduced size so that it can be used with high areal density recording media in the range of about 1 Terabit (Tb) per square inch. The nearfield transducer 200 has shape features in the sub-20 nanometer range. Applicant have found, however, when the nearfield transducer 200 is produced in a size for use in the range of 1 Terabit per square inch, that problems are encountered using conventional processes to manufacture it. In particular, the sharp breakpoints 206, 208 are not present when made using conventional processes. With conventional processes, corners tend to be rounded with an excessively large radius rather that sharply defined as illustrated in FIG. 2. Applicants have found, using processes based on chemically amplified resists and thermal shrinking techniques, that corners are rounded, which seriously degrades the efficiency of an optical transducer in the range of 1 Terabit per square inch. Applicants have also found, using conventional processes, that the disc portion on such smaller transducers tends to distort away from its desired circular, round shape, further reducing efficiency of the transducer 200. The undesirable results discovered using conventional processes are described below in connection with FIGS. 3-4. These undesirable results are avoided by use of the processes described below in connection with FIGS. 5-12.

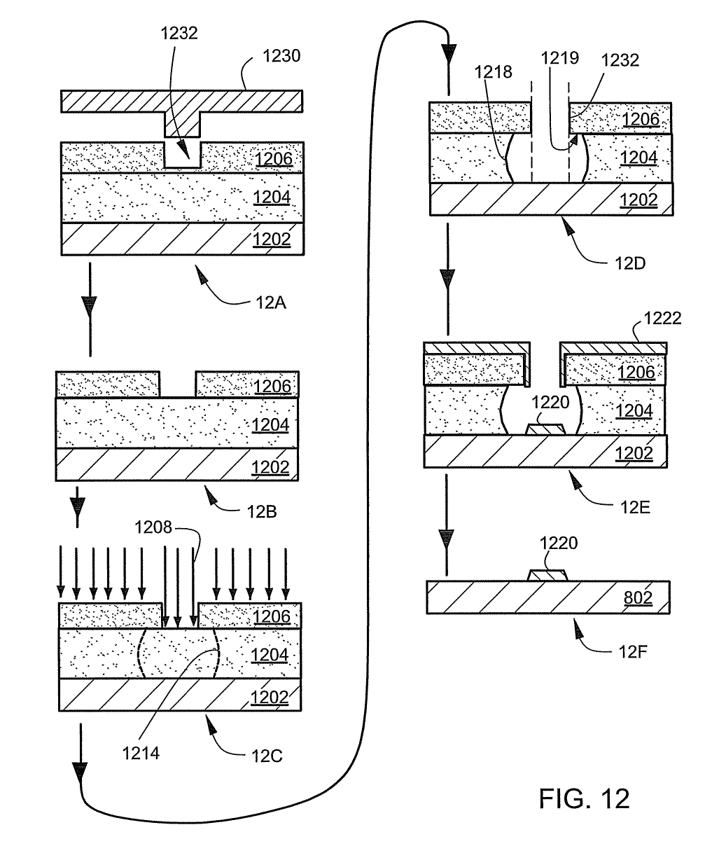

According to one aspect, transducers 200 are manufactured using processes described below in connection with FIG. 5 or FIG. 12. The transducers manufactured using processes described in FIGS. 5, 12 have a disk 202 that has a circular shape and that has a diameter 216 of approximately 200 nanometers (nm), peg widths 210 in the range of 20-50 nm depending on targeted thermal spot sizes and areal densities desired. A peg width 210 of 20 nm corresponds with approximately 1 Tb/square inch. The transducer 200 has a peg length 214 of approximately 10-20 nm, and there is a sharp corner at the breakpoints 206, 208 that provides a well-defined peg length between the breakpoints 206, 208 and a bottom air bearing surface (ABS, not visible in FIG. 2) of the transducer 200. Sharp breakpoints 206, 208 are not obtainable using convention methods in this small size transducer. According to one aspect, the transducer 200 comprises a deposition of gold (Au) with a thickness 212 of approximately 20-30 nm. According to another aspect, the breakpoints 206, 208 have a radius of less than 5-10 nm.

FIG. 3 illustrates an exemplary NFT resist layer pattern 300 that is prepared using conventional methods based on chemically amplified resists and thermal shrinking principles. The resist layer pattern 300 is patterned by conventional e-beam patterning of a resist trench pattern that initially comprises a disk pattern 302 and a peg pattern 304, but that is blurred, particularly where sharp corners are desired, as illustrated. The chemically amplified (CA) resist has critical dimension (CD) blur that rounds corners as illustrated at 308, 310, which originates from acid diffusion as a fundamental resolution limitation of CA resists. The limitations of the conventional process using a chemically amplified (CA) resist results in a trench width 306 that defines a peg width that is too wide for use with areal densities in the range of 1 Tb/square inch.

A further process of thermal shrinking (not illustrated in FIG. 3) is needed to reduce the trench width 306 to a narrow enough width for use with areal densities in the range of 1 Tb/square inch. In a later step (not illustrated), a finished wafer 312 is lapped to form an air bearing surface 314. This further step of shrinking is described in more detail below in connection with FIG. 4.

FIG. 4 illustrates a NFT resist layer pattern during successive stages of anisotropic thermal shrinking along a left-right axis. As illustrated at resist pattern 402, an e-beam pattern, before shrinking, has a trench width of 60 nm, which is too wide for use with areal densities in the range of 1 Tb/square inch. After a first shrinking process, the resist pattern is distorted as illustrated at 404 and has a trench width of 42 nm. After a second final shrinking process, the resist pattern is further distorted as illustrated at 406 and has a trench width of 33 nm. The 33 nm trench width would be usable with areal densities in the range of 1 Tb/square inch, however, the disc is greatly distorted and there is an absence of break points. Because of the distortion of the disc and the absence of break points at shrunk pattern 406, a near field transducer produced using the shrunk pattern 406 would have too low an efficiency to be useful. The processes shown in FIGS. 3 and 4 thus do not produce a usable near field transducer such as the near field transducer 200 illustrated in FIG. 2. In FIG. 4, the thermal shrinking reduces the peg width, but also distorts the disk shape so that it is no longer round.

To overcome the resolution limitation of CA resists, non-CA resists, i.e. chain-scission type resists, are used to form sub-30 nm near field transducers. In addition to improved resolution, the formation of an undercut is introduced in the resist layer to facilitate particle-free liftoff. Undercut formation is achieved, for example, by using an aqueous base-soluble polymethylglutarimide (PMGI) type underlayer, which is often associated with a CA resist also using aqueous base as the developer. However, for polymeric non-CA resists, PMGI-type underlayer materials are not the optimal choices since there are two development processes involved, one is for the resist using organic solvents, the other is for the underlayer material using aqueous bases. Beyond that, the PMGI-type underlayer material is also sensitive to the electron/photon, having sensitivities lower than most CA resists but higher than most non-CA resists. These characteristics make the undercut control difficult, not only depending on many process parameters such as baking temperature/time, developer concentration, and development temperature/time, but also varying with different types of resists with different exposure sensitivities.

In summary, the areal density of HAMR recording relies on the thermal spot size determined by the shape and physical dimensions of a NFT device. Conventional fabrication methods of NFT-like structures involve a CA resist having about 40 nm resolution capability and one or multiple post-lithography chemical or thermal shrink steps. The deterioration of NFT breakpoint sharpness and the disk shape is unavoidable with this approach. Non-CA resists are used to solve the above problems. An undercut formation is provided in the non-CA resist to deliver a particle-free gold (Au) NFT device. A lithographic process is used in fabrication of sub 20 nm NFT devices with greater than 1 Tb/square inch HAMR density.

As described below in connection with FIGS. 5-12, lithographic methods are disclosed that are used to fabricate sub-20 nm NFT devices for HAMR applications. These methods are based on differential dissolution using two polymers with differing molecular weights (MWs). The disclosed methods provide a desired high resolution, sharp breakpoints, and precise undercut control for easy liftoff in NFT fabrication. This method is applicable for fabrication of NFTs, as well as various isolated or semi-dense nanodevices with ultra-high resolution and precise shape-control requirements.

The disclosed lithographic methods allows fabrication of high-quality <20 nm Au NFT devices. In this method, differential dissolution is used to precisely control the undercut formation in a high-resolution polymeric resist to enable high-yield liftoff of small Au NFT structures with good fidelity to original resist patterns.

As illustrated in FIG. 5 step 5A, the resist comprises two polymeric layers 504 and 506. The differential dissolution means the dissolution behaviors of the two polymers can be chosen precisely during process development. According to one aspect, layers 504 and 506 have the same composition and monomer. In this aspect, the photo/electron beam sensitivity of the polymer is determined by the molecular weight (MW) only. Usually the lower the MW, the higher the sensitivity. But the higher the MW, the better the resolution. The polymeric layer 506 with a high MW delivers ultrahigh resolution that guarantees the achievement of sub-20 nm peg width and sharp breakpoint. The polymeric 504 has a lower MW that has higher sensitivity to development by e-beam radiation. Because layers 504 and 506 receive almost the same amount of exposure doses during patterning in e-beam exposure, the post-exposure MW of layer 504 is still lower than that of layer 506. After simultaneous development with the same developer, the feature formed in polymeric layer 504 is wider than the feature formed in polymeric layer 506. An undercut is thus created with a size that can be controlled by adjusting the MW difference between polymeric layers 504 and 506. FIG. 5 illustrates the process flow for applying a differential dissolution method for the fabrication of Au NFT structures.

In FIG. 5 at process stage 5A, the first layer 504 of resist material is deposited on a substrate 502, and the second layer 506 of resist material is deposited on the first layer 504. The second layer 506 comprises a comparatively higher molecular weigh polymeric resist material, and the first layer 504 comprises a comparatively lower molecular weight polymeric resist material in comparison to that of the second layer 506. The first and second layers 504, 506 are both supported on the substrate 502.

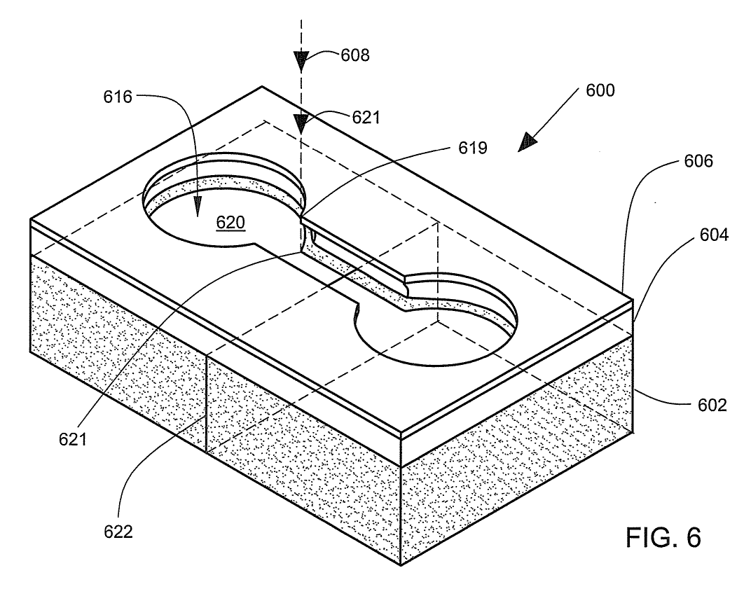

In FIG. 5 at process stage 5B, e-beam radiation 508 in a pattern 510 is directed simultaneously at the first and second layers 504, 506. The pattern 510 of the e-beam radiation 508 defines a shape of an optical transducer that includes a concave metal transducer corner (FIG. 6). According to one aspect, the optical transducer comprises a pattern that defines a shape of a near field transducer.

In FIG. 5 at process stage 5C, the first layer 504 includes a portion 514 that has its characteristics altered by the e-beam radiation, and the second layer 506 includes a portion 512 that has its characteristics altered by the e-beam radiation. The portion 514 is wider that the portion 512 due to an increased blur radius in the lower molecular weight layer 504.

In FIG. 5 at process stage 5D, the first and second layers 504, 506 are developed to form an aperture that includes a narrower aperture 516 in the second layer 506 and a wider aperture 518 in the first layer 504. The second layer 506 includes a resist protrusion 519 that protrudes outward beyond the first layer 504 and that overhangs the substrate 502.

In FIG. 5 at process stage 5E, metal is evaporated through the aperture 516 onto the substrate 502 to form the optical transducer 520. The resist protrusion 519 defines a shape of the optical transducer 520, including a concave metal transducer corner (FIG. 6). Metal 522 is deposited on the layer 506. The metal 522 is separated from the optical transducer 520 by the undercutting of the first layer 504, and thus metal 522 is not connected to the optical transducer 520, resulting in a sharp, well-defined edge on the optical transducer 520 that is free of metal particles.

In FIG. 5 at process stage 5F, layers 504, 506 and 522 have been lifted off the substrate 502, leaving the optical transducer 520 completed on the substrate 502. Since there were no metal connections between the optical transducer 520 and the metal 522 that was lifted off, the optical transducer 520 has sharp, well-defined edges and corners.

In summary, the lithographic methods disclosed here is a very manufacturable solution for the fabrication of sub-20 nm NFT device. The differential dissolution idea using two polymers with different MWs opens a window to satisfy both resolution/sharp breakpoint requirements and precise undercut control for easy liftoff. This method is actually not only limited to NFT fabrication, but also applicable to fabrication of other isolated or semidense nanodevices with ultra-high resolution and precise shape-control requirements.

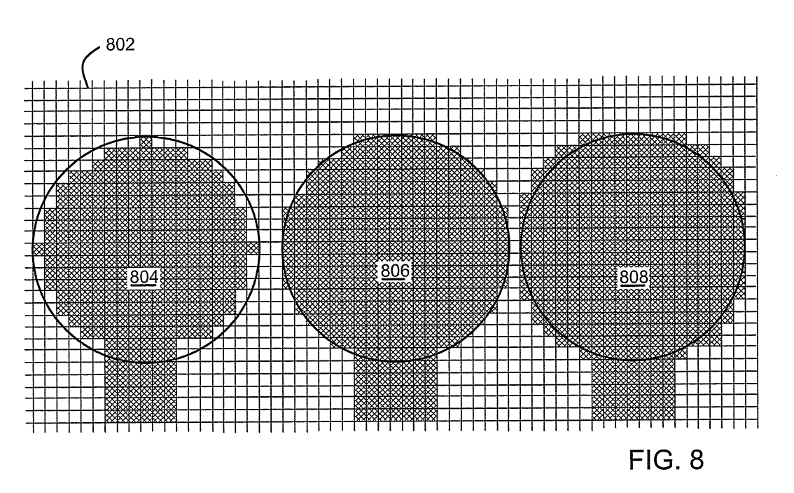

According to one exemplary process, the layer 504 comprises MMA-EL9 (MicroChem Corp., Newton, Mass., USA) and is applied with a thickness of 50-200 nm to the substrate 502 using a hand coater. The layer 504 is baked at 120-180 degrees centigrade for 180 seconds. The layer 506 is then hand applied. The layer 506 comprises 950 PMMA A2 (MicroChem Corp., Newton, Mass., USA) with a thickness of 50-200 nm. Next, e-beam exposure 508 is applied (5B in FIG. 5) using a fixed-to-grid pattern (described in more detail below in connection with FIG. 8). Next, the layers 504, 506 are developed (5C in FIG. 5) with a flow of a mixture of methyl isobutyl ketone (MIBK) and isopropanol (IPA) as developer, IPA or water as rinser for 15-20 seconds). Next, a short time oxygen based reactive ion etching (RIE) is used for descumming. Next, a pre-etch of 1-5 minutes is used before evaporating gold (5E in FIG. 5) to a thickness of 20-30 nm. The device is soaked (5F in FIG. 5) in Microposit 1165 stripper (Shipley Company/Rohm & Haas, Marlboro, Mass., USA) in a vertical beaker for 30-60 min at 60 degrees Centigrade to effect lift-off. Spin-rinse drying is then used to remove the 1165 stripper.

FIG. 6 illustrates an oblique view of an in-process optical transducer 600 (at process stage 5E in FIG. 5). The in-process optical transducer 600 comprises a first layer 604 of resist material and a second layer 606 of resist material on a substrate 602. The second layer 606 comprises a higher molecular weigh resist material than a lower molecular weight resist material of the first layer 604. Previous exposure (at process stage 5B in FIG. 5) to e-beam radiation 608 defines a shape of an optical transducer 620 that includes a concave metal transducer corner 621. The first and second layers 604, 606 are developed to form an aperture 616 that includes a resist protrusion 619 in the second layer 606 that protrudes outward beyond the first layer 604 and that overhangs the substrate 602. Metal vapor 621 was evaporated through the aperture 616 onto the substrate 602 to form the optical transducer 620. The resist protrusion 619 defines a shape of the concave metal transducer corner 621. Evaporated metal deposited on the second layer 606 has been omitted from FIG. 6 for clarity.

In subsequent process steps, the in-process optical transducer 600 has its resist layers 604, 606 lifted off and the substrate 602 is cut and lapped to form an air bearing surface 622. After completion of the cutting and lapping, the optical transducer 620 that is included in in-process transducer 600 has a shape similar to that shown in FIG. 2.

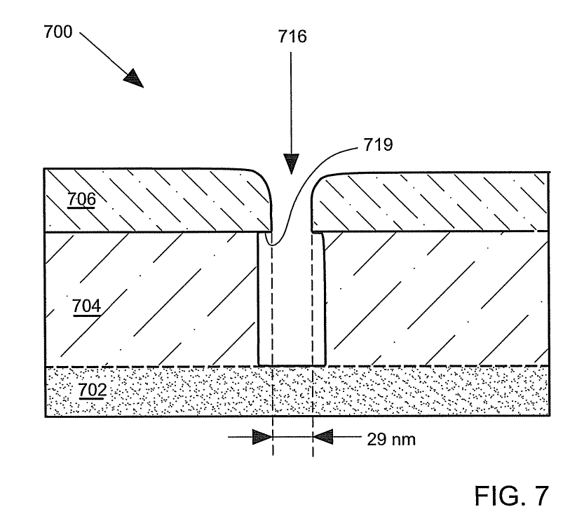

FIG. 7 illustrates an enlarged cross-sectional view (at process stage 5D in FIG. 5) of exemplary resist deposits defining a peg width of about 29 nm for a near field transducer. A first resist layer 704 and a second resist layer 706 are deposited on a substrate 702. An aperture 716 is formed as described above in connection with FIGS. 5 and 6. The second resist layer 706 comprises an overhanging region 719. The resist layer 704 is undercut by blur diffusion relative to the layer 706.

Besides the requirements of narrow peg width and sharp breakpoint in NFT, the shape control of a circular disk area is also important to ensure the NFT efficiency, i.e. an ellipse shape will lower the remanence efficiency of NFT. FIG. 8 illustrates three examples of patterns of NFTs that are fix-to-grid patterns of a circular disc and a peg. A grid 802 represents a raster of actual pixels stepped and flashed by an e-beam. Pattern 804 includes pixels that are fully (100%) inside a circular portion of the pattern. Pattern 806 includes pixels that are 50% to 100% inside a circular portion of the pattern. Pattern 808 includes pixels that are more than 0% inside a circular portion of the pattern. Due to the ultrahigh resolution and sub-10 nm image blur in the resist used, pattern 806 provides a preferred rasterized shape with almost ideal circular shape of the disk in the NFT.

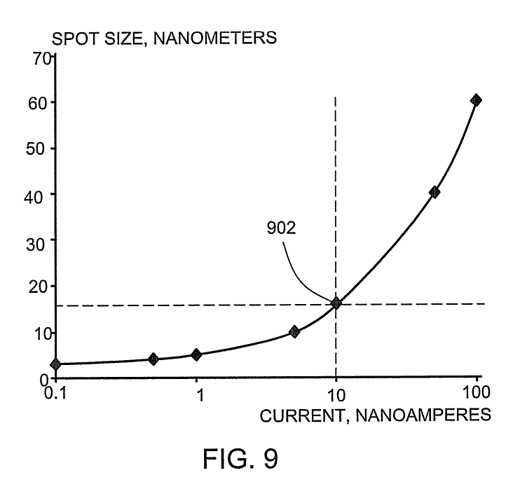

A low line edge roughness (LER) resist development process is used, according to one aspect, to generate high-resolution feature with smooth line edges. The exposure tool is a Leica VB6-HR from Leica Microsystems GmbH of Wetzlar, Germany, operated at 100 kV with 5-10 nA current. As illustrated in FIG. 9, the beam current of 5-10 nA at 100 kV provides a desirable small spot size (beam diameter) of 10-16 nm at 902. The small spot size results in low levels of CD blur in sub-20 nm NFTs when used with resist developer isopropanol (IPA) or mixture of IPA and methyl isobutyl ketone (MIBK) with IPA as the dominant component (>80-90% volume fraction). This kind of developer is a poor solvent to most non-CA resists and can reduce resist fluctuation and minimize swelling after development, which is a key point to get low LER in resist pattern.

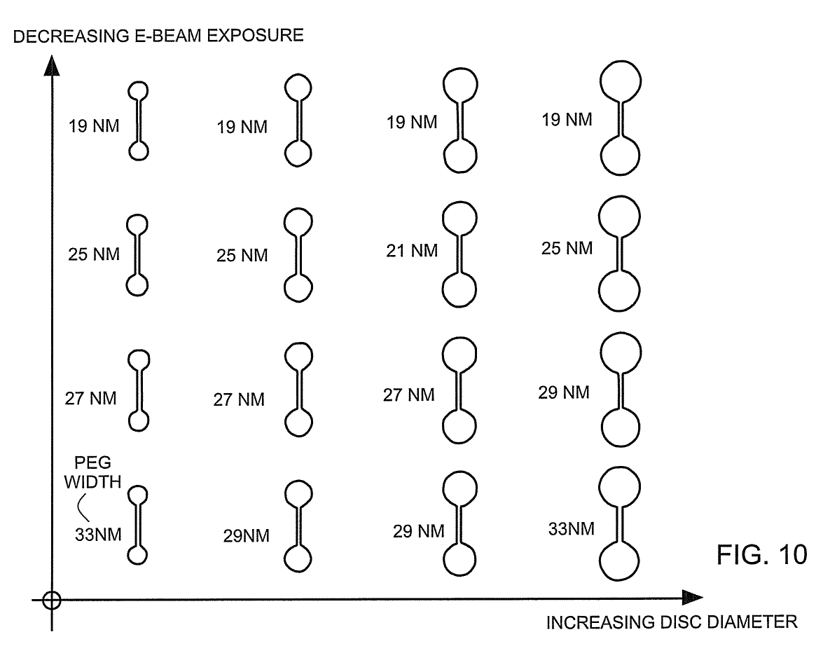

FIG. 10 illustrates a series of NFTs prepared using the method of FIG. 5 with peg widths varying from 19 nm to 33 nm and disk diameters varying from 150 nm to 300 nm. As illustrated in FIG. 10, sharp concave sub-20 nm corners at the junction of pegs and discs are present in the series of devices.

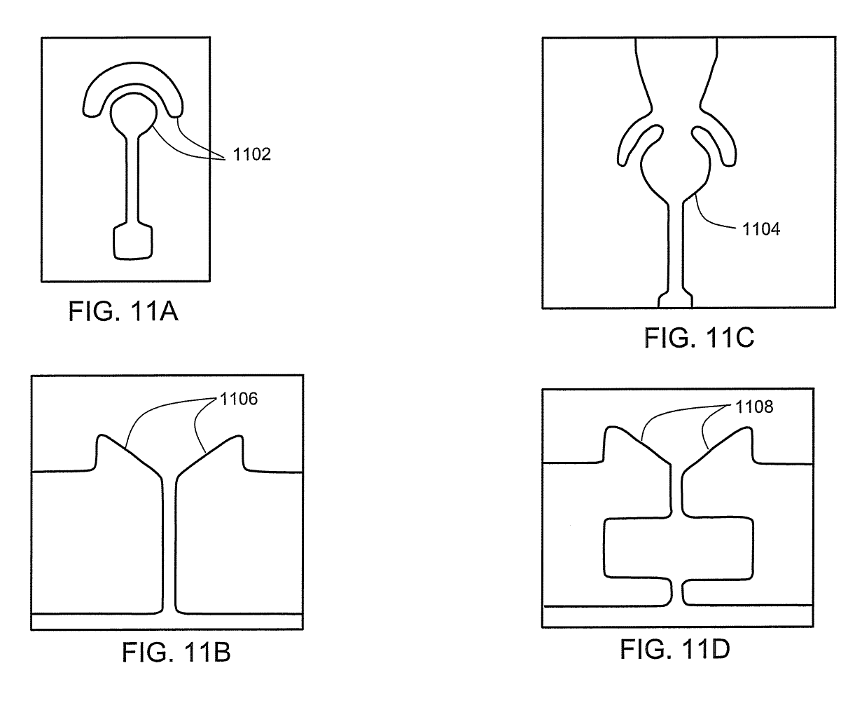

FIGS. 11A, 11B, 11C, 11D illustrate alternative shapes 1102, 1104, 1106, 108 of NFTs that are formed using the disclosed methods in FIG. 5. The alternative shapes indicate that the method enables the fabrication of sub-20 nm NFT device to extend HAMR to greater than 1 Tb/square inch regimes.

FIG. 12 illustrates process stages 12A, 12B, 12C, 12D, 12E and 12F in a process for manufacturing an optical transducer. The optical transducer manufactured in the process illustrated in FIG. 12 is similar to the optical transducer manufactured in the process illustrated in FIG. 5. In FIG. 12 at stage 12A, a nano-imprinting lithography (NIL) mold 1230 is used to imprint a pattern of an optical transducer in a second resist layer 1206, which avoids the need for patterning of e-beam radiation exposure. In FIG. 5, however, e-beam radiation is patterned which avoids the need for a NIL mold.

The differential dissolution of resist layers 1204, 1206 disclosed herein can be applied to not only an e-beam or optical lithography processes, but also to a nanoimprinting process. Sub-20 nm isolated or semi-dense transducer features can be generated via a liftoff method with either process.

At process stage 12A, a second resist layer 1206 with a high-MW polymer on top and a first resist layer 1204 with a low-MW polymer below is used on a substrate 1202. An ultranarrow trench 1232 is pressed into the second resist layer 1206 by the NIL mold 1230 with a very finely shaped tip having a NFT shape. After a short descum at process stage 12B, the first resist layer 1204 is exposed through the trench 1232. Then at process stage 12C a flood (unpatterned) e-beam radiation 1208 using polymer sensitive photons like EUV, 193 nm, 248 nm, 365 nm is performed to mainly degrade the first resist layer 1204. The second resist layer 1206 is almost untouched due to its much higher MWs and lower exposure sensitivity. After a mild wet development process at process stage 12D, the degraded bottom layer polymer is washed away so as to form an undercut 1219. In this case, the undercut 1219 is still mainly determined by the distinct dissolution behavior between the two resist layers 1204, 1206 due to different MWs.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular methods may vary depending on the particular application for the optical transducer while maintaining substantially the same functionality without departing from the scope and spirit of the present invention. In addition, although the preferred embodiment described herein is directed to a flat metal optical transducer for heat assisted magnetic recording, it will be appreciated by those skilled in the art that the teachings of the present invention can be applied to optical transducers that are not flat, without departing from the scope and spirit of the present invention.

What is claimed is:

1. A process, comprising:
depositing first and second layers on a substrate, the second layer comprising a resist material with a higher molecular weigh than a lower molecular weight resist material of the first layer;
defining a shape of an optical transducer that includes a concave metal transducer corner;
providing e-beam radiation to the first and second layers;
developing the first and second layers to form an aperture that includes a resist protrusion in the second layer that protrudes outward beyond the first layer and that overhangs the substrate;
evaporating metal through the aperture onto the substrate to form the optical transducer, the resist protrusion defining a shape of the concave metal transducer corner; and
lifting off the first and second resist layers.

2. The process of claim 1 and forming the concave metal transducer corner at an intersection of a stripe portion and a round portion of the optical transducer.

3. The process of claim 1 and the lower molecular weight material in the first layer providing an image blur radius of the e-beam radiation.

4. The process of claim 1 wherein the e-beam radiation includes a raster grid, and rasterizing the e-beam radiation to include a pattern of the optical sensor in the optical grid, the pattern being fixed to the raster grid.

5. The process of claim 1 wherein the developing of the first and second layers is performed in a weak developer that enhances undercutting of the first layer.

6. The process of claim 1 wherein the metal comprises gold.

7. The process of claim 1 wherein the defining of the shape of the optical transducer comprises imprinting the second layer of resist material with a nano-imprinting lithography mold.

8. A process, comprising:
depositing first and second layers on a substrate, the second layer comprising a resist material with a higher molecular weigh than a lower molecular weight resist material of the first layer;
providing e-beam radiation to the first and second layers, the e-beam radiation defining a shape of an optical transducer that includes a metal transducer corner;
developing the first and second layers to form an aperture that includes a resist protrusion in the second layer that protrudes outward beyond the first layer;
depositing metal through the aperture onto the substrate to form the optical transducer, the resist protrusion defining a shape of the metal transducer corner; and
removing the first and second resist layers.

9. The process of claim 8 wherein the e-beam radiation is provided simultaneously to the first and second layers.

10. The process of claim 8, wherein the developing is provided simultaneously to the first and second layers.

11. The process of claim 8 wherein the optical transducer comprises a near field transducer.

12. The process of claim 8 wherein the optical transducer is disposed in a heat assisted magnetic recording device.

13. The process of claim 8, wherein the developing comprises applying isopropanol.

14. The process of claim 8, wherein the developing comprises applying a mixture of isopropanol and methyl isobutyl ketone.

15. A process, comprising:
depositing first and second layers on a substrate, the second layer comprising a resist material with a higher molecular weigh than a lower molecular weight resist material of the first layer;
pressing a shape of an optical transducer that includes a metal corner into the second layer with a nano-imprinting lithography mold;
providing e-beam radiation to the first and second layers;
developing the first and second layers to form an aperture that includes a resist protrusion in the second layer that protrudes outward beyond the first layer;
depositing metal through the aperture onto the substrate to form the optical transducer, the resist protrusion defining a shape of the metal transducer corner; and
removing the first and second resist layers.

16. The process of claim 15 wherein the e-beam radiation is provided simultaneously to the first and second layers.

17. The process of claim 15 wherein the developing is provided simultaneously to the first and second layers.

18. The process of claim 15 wherein the optical transducer comprises a near field transducer.

19. The process of claim 15 wherein the optical transducer is disposed in a heat assisted magnetic recording device.

20. The process of claim 15 wherein the developing comprises applying isopropanol.
